(19) United States
(12) Patent Application Publication
(10) Pub. No.: US 2014/0083254 A1
(43) Pub. Date: Mar. 27, 2014

(54) ASSEMBLED DAMPING HAMMER

(71) Applicant: LUCKY-BRAND INDUSTRIAL CO., LTD., Taichung City (TW)

(72) Inventor: Chien-Wen CHANG, Taichung City (TW)

(73) Assignee: LUCKY-BRAND INDUSTRIAL CO., LTD., Taichung City (TW)

(21) Appl. No.: 13/649,791

(22) Filed: Oct. 11, 2012

(30) Foreign Application Priority Data
Sep. 26, 2012 (TW) 101135429

(51) Int. Cl. B25D 1/12

(52) U.S. Cl. 81/22

(57) ABSTRACT

An assembled damping hammer comprises a body having at least a first joining surface, a damping block detachably disposed on the body and having at least a second joining surface attached to the first joining surface of the body and at least a third joining surface and a working piece detachably disposed on the damping block and having a contact surface and at least a fourth joining surface attached to the third joining surface of the damping block. At least one of the second and the third joining surfaces of the damping block is oblique with respect to the contact surface. Thereby, the working piece of the assembled damping hammer can be detached and replaced by a user according to demands, and the assembled damping hammer has low vibration strength when being used and, thus, can be stably held by the user and avoid causing damage to the user.

### BACKGROUND OF THE INVENTION

1. Technical Field

The present invention relates to hammering tools such as hammers, and more particularly, to an assembled damping hammer.

2. Description of Related Art

A conventional hammering tool such as a hammer mainly comprises a hammerhead and a handle rod. Two ends of the hammerhead are usually a hammering portion and a nail-drawing portion respectively, and the handle rod extends outwards substantially perpendicular to the hammerhead from a middle section of the hammerhead. A user holds the handle rod to wield the hammering tool towards a target so that the hammering portion of the hammerhead hits the target. The handle rod is usually further covered with a handle sheath so that the handle rod can be held by the user more stably through the handle sheath.

However, the target that is hit usually applies a relatively large counterforce to the hammering portion of the hammerhead to vibrate the hammering tool, and the hammering tool that is vibrated violently will hit the user's hand that holds the hammer. This is not only prone to causing damage to the user's hand, but is also likely to damage the user's brain or other parts. Moreover, vibration of the hammering tool also makes it difficult for the user to stably hold the hammering tool even through the handle sheath.

Additionally, apart from the hammers, there are other different hammering tools on the market. Hammerheads of the hammering tools may be made of wood, stainless steel, rubber and the like, and the same materials further have differences in hardness. If the user has various application demands, then multiple different hammering tools must be purchased. This not only occupies a large space, but also leads to a low cost efficiency.

### SUMMARY OF THE INVENTION

In view of the aforesaid shortcomings, a primary objective of the present invention is to provide an assembled damping hammer, which applies a reduced vibration strength to the user's hand and, thus, can avoid causing damage to the user and can be held by the user more stably.

Another objective of the present invention is to provide an assembled damping hammer which has a working piece for acting on (e.g., hitting) a target, and the working piece can be detached and replaced by the user.

To achieve the aforesaid objectives, the present invention provides an assembled damping hammer, which comprises a body, a damping block and a working piece. The body has a handle rod and a head portion connected to the handle rod, and the head portion has at least a first joining surface. The damping block has at least a second joining surface and at least a third joining surface, the damping block is detachably disposed on the head portion of the body, and the second joining surface of the damping block is attached to the first joining surface of the body. The working piece has a contact surface and at least a fourth joining surface, the working piece is detachably disposed on the damping block, and the fourth joining surface of the working piece is attached to the third joining surface of the damping block. At least one of the second joining surface and the third joining surface of the damping block is oblique with respect to the contact surface of the working piece.

In other words, the second joining surface of the damping block and the first joining surface of the body are oblique with respect to the contact surface of the working piece; or the third joining surface of the damping block and the fourth joining surface of the working piece are oblique with respect to the contact surface of the working piece; or the first, the second, the third and the fourth joining surfaces described above are all oblique with respect to the contact surface of the working piece. Thereby, the counterforce applied to the contact surface by the target (e.g., the object being hit) is decomposed by the oblique first joining surface and the oblique second joining surface, or is decomposed by the oblique third joining surface and the oblique fourth joining surface, or is firstly decomposed by the third joining surface and the fourth joining surface and then decomposed by the first joining surface and the second joining surface. In this way, the counterforce is dispersed so that the vibration strength applied to the user's hand is reduced. This can not only avoid causing damage to the user, but can also allow the user to hold the assembled damping hammer more stably. Moreover, the user can further replace the working piece of the assembled damping hammer with a working piece of different material, hardness, shape or function according to different application demands.

The detailed construction, features, assembling or operating manners of the assembled damping hammer of the present invention will be described in the following

### DETAILED DESCRIPTION OF THE EMBODIMENTS OF THE INVENTION

However, it shall be appreciated by those of ordinary skill in the art that, the detailed description and specific embodiments enumerated for implementation of the present invention are only intended to illustrate the present invention but not to limit the scope of the present invention.

### BRIEF DESCRIPTION OF THE SEVERAL VIEWS OF THE DRAWINGS

FIG. 1 is a perspective assembly view of an assembled damping hammer according to a first preferred embodiment of the present invention;

FIG. 2 and FIG. 3 are perspective exploded views of the assembled damping hammer according to the first preferred embodiment of the present invention;

FIG. 4 is a perspective view of a damping block of the assembled damping hammer according to the first preferred embodiment of the present invention;

FIG. 5 is a perspective view of a working piece of the assembled damping hammer according to the first preferred embodiment of the present invention;

FIG. 6 is a cross-sectional view of FIG. 1 taken along a line 6-6, where the working piece of the assembled damping hammer is fixed in a plughole of a body by a fixing piece;

FIG. 7 is similar to FIG. 6, but illustrates an aspect where the working piece is not fixed to the body by the fixing piece;

FIG. 8 is similar to FIG. 7, but illustrates an aspect where the working piece is pushed outwards from the plughole of the body by the fixing piece;

FIG. 9 is a partial perspective assembly view of an assembled damping hammer according to a second preferred embodiment of the present invention; and

FIG. 10 is a cross-sectional view of the assembled damping hammer according to the second preferred embodiment of the present invention.

### DETAILED DESCRIPTION OF THE EMBODIMENTS OF THE INVENTION

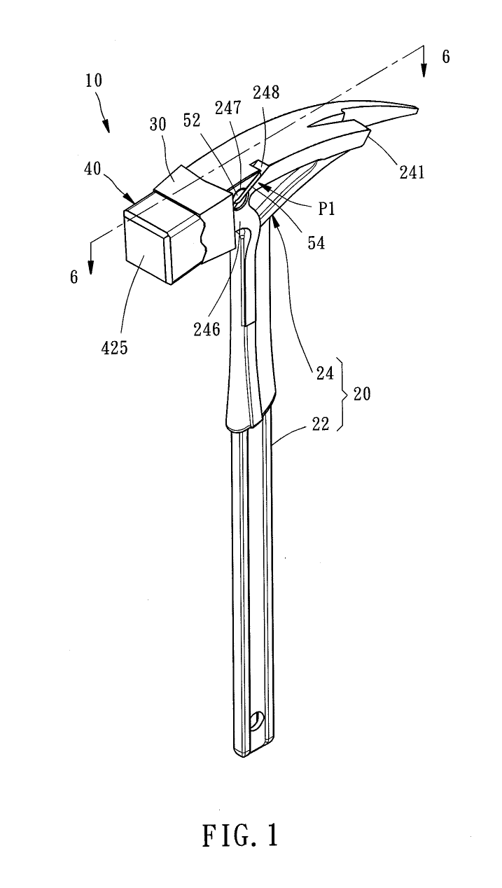

Referring to FIG. 1 to FIG. 5, an assembled damping hammer 10 according to a first preferred embodiment of the present invention comprises a body 20, a damping block 30, a working piece 40 and a fixing piece 50.

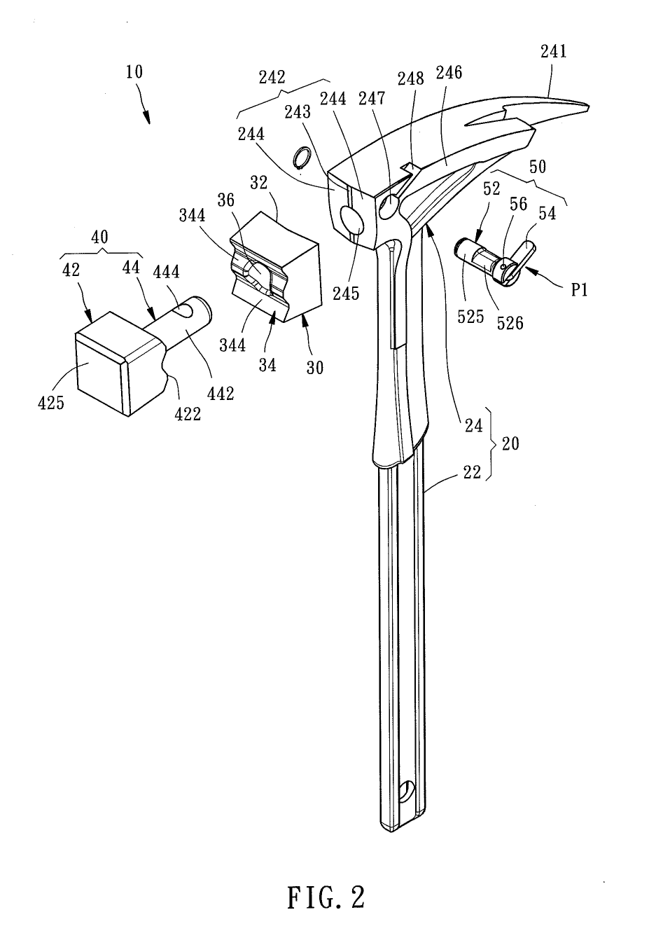

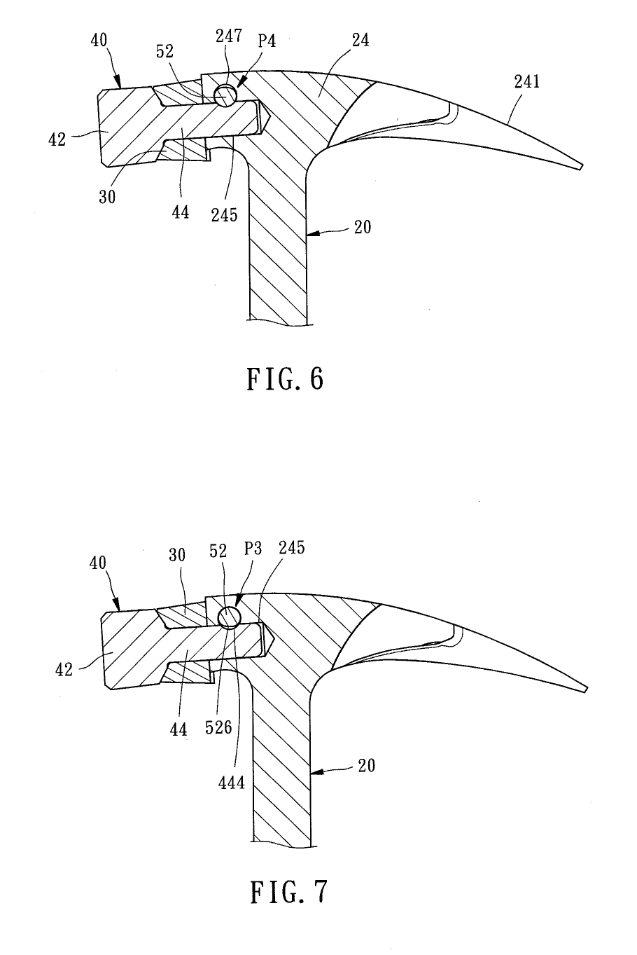

The body 20 has a handle rod 22 and a head portion 24 that is integrally connected to an end of the handle rod 22; and the handle rod 22 and the head portion 24 are not limited to being integrally formed provided that they are fixed to each other. The head portion 24 has a nail-drawing structure 241 at an end thereof. The form and functions of the nail-drawing structure 241 are already known in the prior art and, thus, will not be further detailed by this applicant herein. As shown in FIG. 2, the head portion 24 has a protrusion structure 242 at the other end thereof, and the protrusion structure 242 is formed by a flat surface 243 that extends longitudinally and two first joining surfaces 244. The two first joining surfaces 244 extend transversely from the flat surface 243 and are oblique towards the nail-drawing structure 241. The head portion 24 further has a plughole 245 that extends from the flat surface 243 and the first joining surfaces 244 towards the nail-drawing structure 241. Furthermore, the head portion 24 has a side surface 246, and a through hole 247 and an elongated receiving groove 248 extending outwards from the through hole 247 which are formed in the side surface 246; and the through hole 247 intersects and communicates with the plughole 245 (as shown in FIG. 6).

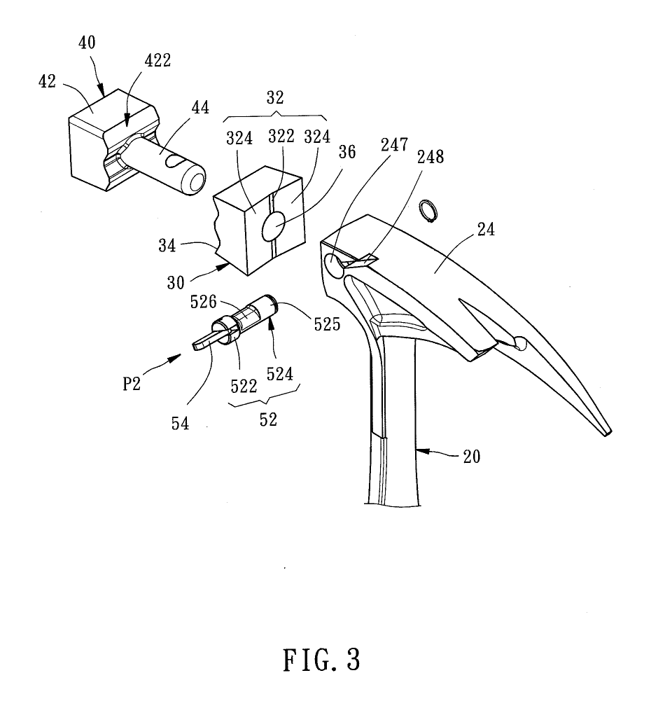

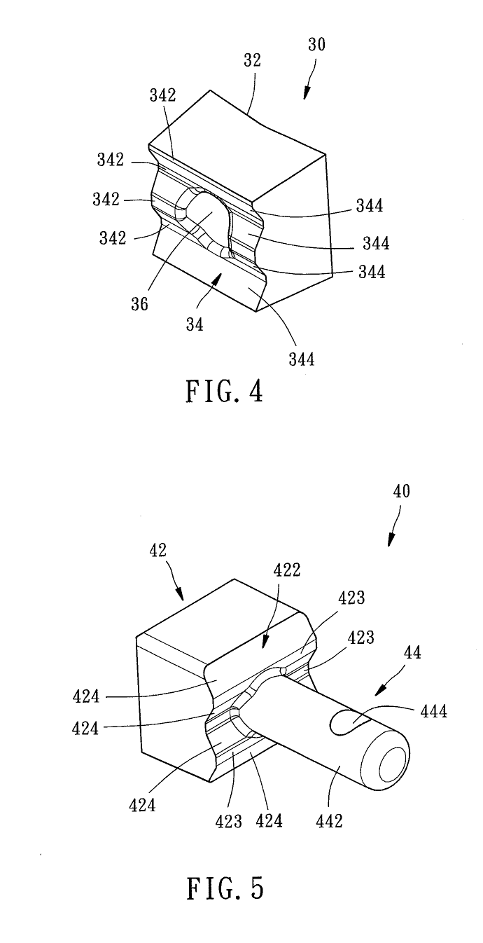

The damping block 30 is made of an elastic material such as polyurethane (PU), and is approximately in the form of a trapezoidal column. However, the damping block 30 has, at an end thereof, a recess structure 32 that is approximately complementary in form to the protrusion structure 242 of the body 20, and has a wave structure 34 at the other end thereof. As shown in FIG. 3, the recess structure 32 is formed by a flat surface 322 that extends longitudinally and two second joining surfaces 324 that extend obliquely in a transverse direction from the flat surface 322. As shown in FIG. 4, the wave structure 34 is formed through alternate connection of four flat surfaces 342 that extend transversely and four third joining surfaces 344 that are longitudinally oblique with respect to the flat surfaces 342. Furthermore, the damping block 30 further has a through hole 36 that extends through the aforesaid two ends.

As shown in FIG. 5, in this embodiment, the working piece 40 is a hammering piece, and has a hammering portion 42 and a cylindrical fixing portion 44 which are integrally connected to each other. The hammering portion 42 is approximately in the form of a rectangular column, but has, at an end thereof, a wave structure 422 which is approximately complementary in form to the wave structure 34 of the damping block 30. The wave structure 422 is formed through alternate connection of three flat surfaces 423 that extend transversely and four fourth joining surfaces 424 that are longitudinally oblique with respect to the flat surfaces 423. As shown in FIG. 2, the hammering portion 42 has a contact surface 425 at the other end thereof, and the fixing portion 44 protrudes substantially perpendicular to the contact surface 425 from a center of the wave structure 422. The fixing portion 44 has a peripheral surface 442 and a groove 444 recessed from the peripheral surface 442.

The fixing piece 50 comprises a column 52 and a spanner 54. The column 52 has a head portion 522 with a larger outer diameter and a body portion 524 with a smaller outer diameter, and the body portion 524 has a peripheral surface 525 and a recess portion 526 recessed from the peripheral surface 525. The spanner 54 is pivoted to the head portion 522 of the column 52, and is capable of swinging between a retraction position P1 (as shown in FIG. 2) and an action position P2 (as shown in FIG. 3) about a pivot 56 which is perpendicular to an axial direction of the column 52.

During assembly of the assembled damping hammer 10, the wave structure 422 of the working piece 40 is opposite to the wave structure 34 of the damping block 30, and the fixing portion 44 extends through the through hole 36 of the damping block 30. The column 52 of the fixing piece 50 rotatably extends through the through hole 247 of the body 20. When the column 52 is located at a releasing position P3 as shown in FIG. 7, the recess portion 526 of the column 52 faces towards the plughole 245 of the body 20. At this point, the fixing portion 44 of the working piece 40 can be inserted into the plughole 245. Then, the user positions the spanner 54 at the action position P2, and rotates the column 52 to an abutting position P4 as shown in FIG. 6 in a counterclockwise direction (from the visual angle of FIG. 7) by means of the spanner 54 so that a part of the peripheral surface 525 of the column 52 is located in the plughole 245. Then, the column 52 is engaged with the groove 444 of the fixing portion 44 so that the fixing portion 44 is fixed between the column 52 and the body 20 and cannot disengage from the plughole 245. In the process of engaging the column 52 with the groove 444, the column 52 also pushes the working piece 40 towards the nail-drawing structure 241 slightly so that the damping block 30 is clamped between the hammering portion 42 of the working piece 40 and the head portion 24 of the body 20. In this way, the second joining surfaces 324 of the damping block 30 are closely attached to the first joining surfaces 244 of the body 20 respectively, and the fourth joining surfaces 424 of the working piece 40 are closely attached to the third joining surfaces 344 of the damping block 30 respectively.

As described above, each of the joining surfaces 244, 324, 344, 424 of the assembled damping hammer 10 is oblique with respect to the contact surface 424. Therefore, when the user hits a target (not shown) with the contact surface 424, the counterforce applied to the contact surface 424 by the target will be decomposed for the first time when passing through the third joining surfaces 344 and the fourth joining surfaces 424 and then decomposed for the second time when passing through the first joining surfaces 244 and the second joining surfaces 324. Moreover, because the third joining surfaces 344 and the fourth joining surfaces 424 are longitudinally oblique while the first joining surfaces 244 and the second joining surfaces 324 are transversely oblique, the counterforce will be dispersed in multiple directions without generating a strong acting force in a single direction. Therefore, the vibration strength applied to the user's hand by the assembled damping hammer 10 under the counterforce is relatively low, and this can avoid causing damage to the user's hand or other parts and can allow the user to hold the assembled damping hammer 10 more stably.

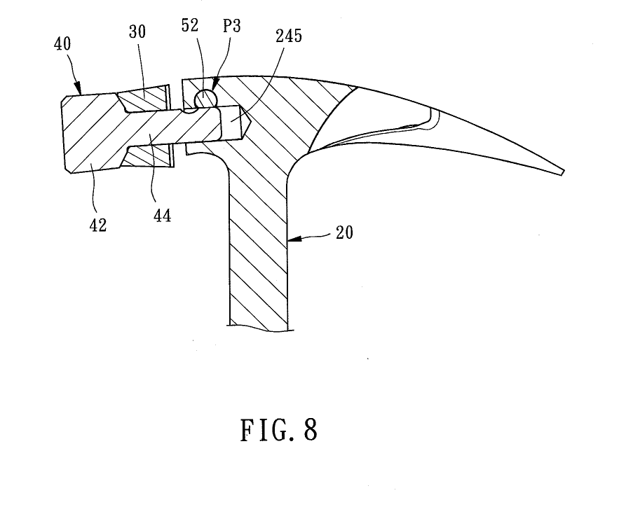

Referring to FIG. 6 and FIG. 8, the user can pull the fixing portion 44 of the working piece 40 out of the plughole 245 of the body 20 simply by clockwise rotating the column 52 from the abutting position P4 so as to restore the column 52 to the releasing position P3. During the aforesaid rotation, the column 52 will push the working piece 40 outwards from the plughole 245, which makes it easier for the user to pull the fixing portion 44 of the working piece 40 out of the plughole 245 of the body 20. Thereby, when the working piece 40 wears down or the damping block 30 suffers from elastic fatigue and cannot be used, the user can easily replace the working piece 40 or the damping block 30. Moreover, the user may also replace the working piece 40 with a hammering piece of different material, hardness or form according to different application demands, and may even replace the working piece 40 with a component having the non-hammering functions (e.g., functions of a screwdriver, or functions of a spanner) so long as the component has a part similar to the fixing portion 44 of the working piece 40 and can be fixed to the body 20. Therefore, the assembled damping hammer 10 is particularly cost-effective.

In addition, when the column 52 of the fixing piece 50 is located at the abutting position P4, the user can pivot the spanner 54 to the retraction position P1 and the spanner 54 can be exactly disposed in the receiving groove 248 of the body 20 (as shown in FIG. 1). This can not only prevent the spanner 54 from obstructing the user in using the assembled damping hammer 10, but can also ensure that the fixing portion 44 of the working piece 40 is clamped by the column 52 in a particularly secure way simply by rotating, by means of the spanner 54, the column 52 to a position where the spanner 54 can be disposed in the receiving groove 248 each time after the user replaces the working piece 40 or the damping block 30.

It is worth mentioning that, the vibration strength applied to the user's hand can be reduced so long as the counterforce applied to the assembled damping hammer 10 is decomposed for at least one time. Therefore, the assembled damping hammer 10 may only have oblique surfaces capable of decomposing a force (i.e., the first joining surfaces 244 and the second joining surfaces 324) at the joint between the body 20 and the damping block 30, or may only have oblique surfaces capable of decomposing a force (i.e., the third joining surfaces 344 and the fourth joining surfaces 424) at the joint between the damping block 30 and the working piece 40; and there is no limitation on the numbers and the oblique directions of the joining surfaces 244, 324, 344, 424. In addition, the construction of the fixing piece 50 is not limited to what described in this embodiment provided that the fixing piece 50 can selectively fix the fixing portion 44 of the working piece 40 to the body 20. Further, the forms of the damping block 30 and the hammering portion 42 of the working piece 40 are not limited to what described in this embodiment either.

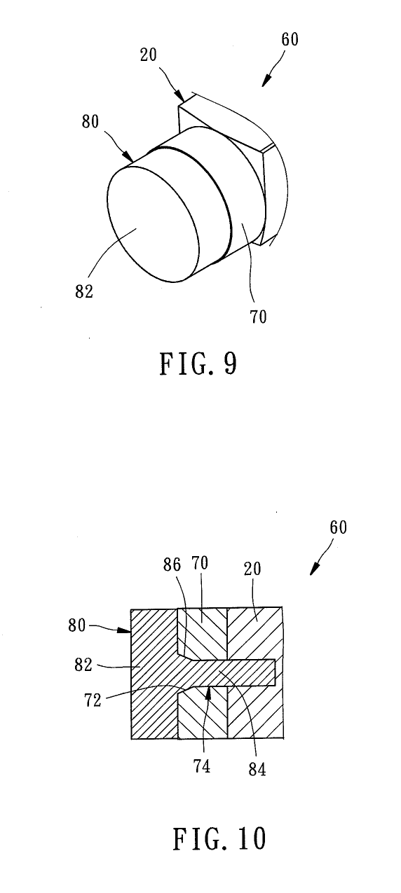

For example, referring to FIG. 9 and FIG. 10, an assembled damping hammer 60 according to a second preferred embodiment of the present invention has a damping block 70 which is approximately in the form of a cylinder, and a hammering portion 82 of a working piece 80 of the assembled damping hammer 60 is also in the form of a cylinder. Furthermore, a third joining surface 72 of the damping block 70 which is oblique and capable of decomposing a force is located at an end of a through hole 74 of the damping block 70 that is adjacent to the hammering portion 82, and surrounds a fixing portion 84 of the working piece 80. Correspondingly, a fourth joining surface 86 of the working piece 80 which is oblique and capable of decomposing a force is located at the fixing portion 84 and is in the circular form. In this way, the third joining surface 72 and the fourth joining surface 86 which are in the circular form can disperse the counterforce, which is applied to the hammering portion 82, averagely in individual directions.

Finally, it shall be appreciated again that, the elements disclosed in the aforesaid embodiments of the present invention are only illustrative but are not intended to limit the scope of the present invention, and replacements or variations of other equivalent elements shall also fall within the scope of the appended claims.

What is claimed is:

1. An assembled damping hammer, comprising:
a body, having a handle rod and a head portion connected to the handle rod, the head portion having at least a first joining surface;
a damping block, having at least a second joining surface and at least a third joining surface, the damping block being detachably disposed on the head portion of the body, and the second joining surface of the damping block being attached to the first joining surface of the body; and
a working piece, having a contact surface and at least a fourth joining surface, the working piece being detachably disposed on the damping block, the fourth joining surface of the working piece being attached to the third joining surface of the damping block, and at least one of the second joining surface and the third joining surface of the damping block being oblique with respect to the contact surface of the working piece.

2. The assembled damping hammer of claim 1, wherein the second joining surface and the third joining surface of the damping block are both oblique with respect to the contact surface of the working piece, and are transversely oblique and longitudinally oblique respectively.

3. The assembled damping hammer of claim 1, wherein the head portion of the body has a plurality of first joining surfaces, the damping block has a plurality of second joining surfaces which are attached to the first joining surfaces of the body respectively, and the first joining surfaces and the second joining surfaces are oblique with respect to the contact surface of the working piece.

4. The assembled damping hammer of claim 1, wherein the damping block has a plurality of third joining surfaces, the working piece has a plurality of fourth joining surfaces which are attached to the third joining surfaces of the damping block respectively, and the third joining surfaces and the fourth joining surfaces are oblique with respect to the contact surface of the working piece.

5. The assembled damping hammer of claim 1, wherein the body has a plughole, the damping block has a through hole, the working piece has a fixing portion, and the fixing portion of the working piece extends through the through hole of the damping block and is inserted into the plughole of the body.

6. The assembled damping hammer of claim 5, further comprising a fixing piece, wherein the fixing piece is disposed in the body, and is capable of selectively fixing the fixing portion of the working piece to the body.

7. The assembled damping hammer of claim 6, wherein the body has a through hole which intersects and communicates with the plughole; the fixing piece comprises a column, the column has a peripheral surface and a recess portion recessed from the peripheral surface, the column is capable of rotatably extending through the through hole of the body between an abutting position and a releasing position; when the column is located at the abutting position, a part of the peripheral surface of the column is located in the plughole and fixes the fixing portion of the working piece between the column and the body; and when the column is located at the releasing position, the fixing portion of the working piece is opposite to the recess portion of the column and is capable of disengaging from the plughole.

8. The assembled damping hammer of claim 7, wherein the fixing portion of the working piece has a peripheral surface and a groove recessed from the peripheral surface, and the column is engaged with the groove of the fixing portion of the working piece when the column is located at the abutting position.

9. The assembled damping hammer of claim 7, wherein the fixing piece further comprises a spanner adapted to rotate the column, and the spanner is pivoted to the column.

10. The assembled damping hammer of claim 9, wherein the body has a receiving groove extending outwards from the through hole, the spanner is capable of swinging between a retraction position and an action position with respect to the column, the spanner is capable of rotating the column when being located at the action position, and the spanner is located in the receiving groove when the spanner is located at the retraction position and the column is located at the abutting position.
